(19) United States
(12) Patent Application Publication
(10) Pub. No.: US 2026/0208244 A1
(43) Pub. Date: Jul. 23, 2026

(54) FISHING LINE REFORMING FOR SAFE DISPOSAL

(71) Applicant: Mark Lewis, Xenia, OH (US)

(72) Inventor: Mark Lewis, Xenia, OH (US)

(21) Appl. No.: 19/028,243

(22) Filed: Jan. 17, 2025

(51) Int. Cl. B09B 3/32; B09B 3/40; B09B 101/75; B29C 43/02; B29C 43/36; B29C 43/52

(52) U.S. Cl. CPC B09B 3/32; B09B 3/40; B29C 43/02; B29C 43/361; B29C 43/52; B09B 2101/75; B29C 2043/3628; B29K 2827/18

(57) ABSTRACT

A forming device for forming fishing line into a compacted form that is safe to dispose of without the risk of harm caused by tangling includes a container with a bottom wall and a perimeter wall. The perimeter wall is coupled to and extends upwardly from the bottom wall. The container defines an interior volume bounded by the bottom wall and the perimeter wall. A plunger is slidably coupled to the interior volume of the container, and a heater is provided which is configured to transmit heat into the interior volume of the container.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### g) BACKGROUND OF THE INVENTION

### (1) Field of the Invention

The disclosure relates to forming devices and more particularly pertains to a new forming device for forming fishing line into a compacted form that is safe to dispose of without the risk of harm caused by tangling.

### (2) Description of Related Art Including Information Disclosed Under 37 CFR 1.97 and 1.98

The prior art discloses numerous forming devices for recycling of plastics. However, the prior art fails to describe a device which has a container for holding wadded up fishing line, a heater for heating the fishing line until it is reformable, and a plunger for manually compressing the fishing line to form a compacted shape during or after heating the fishing line.

### (h) BRIEF SUMMARY OF THE INVENTION

An embodiment of the disclosure meets the needs presented above by generally comprising a container with a bottom wall and a perimeter wall. The perimeter wall is coupled to and extends upwardly from the bottom wall. The container defines an interior volume bounded by the bottom wall and the perimeter wall. A plunger is slidably coupled to the interior volume of the container, and a heater is provided which is configured to transmit heat into the interior volume of the container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a forming device according to an embodiment of the disclosure.

FIG. 2 is a side view of an embodiment of the disclosure depicting a lid in a closed position.

FIG. 3 is a side view of an embodiment of the disclosure depicting a lid in an open position.

FIG. 4 is a top view of an embodiment of the disclosure.

FIG. 5 is a cross-sectional view of an embodiment of the disclosure taken from Line 5-5 in FIG. 4.

FIG. 6 is a side in-use view of an embodiment of the disclosure depicting a wadded up segment of fishing line being placed into a container.

FIG. 7 is a cross-sectional in-use view of an embodiment of the disclosure taken from Line 7-7 in FIG. 4, depicting the fishing line from FIG. 6 within an interior volume of the container and a plunger positioned above the fishing line.

FIG. 8 is a cross-sectional in-use view of an embodiment of the disclosure taken from Line 8-8 in FIG. 4, depicting the fishing line from FIG. 7 within the interior volume of the container and the plunger being pressed against the fishing line.

FIG. 9 is a side in-use view of an embodiment of the disclosure showing the fishing line from FIG. 8 being removed from the container in a newly compacted and set form.

FIG. 10 is a cross-sectional view of an embodiment of the disclosure from the same perspective as FIG. 5 in which the plunger is actuated by a linear actuator.

### (J) DETAILED DESCRIPTION OF THE INVENTION

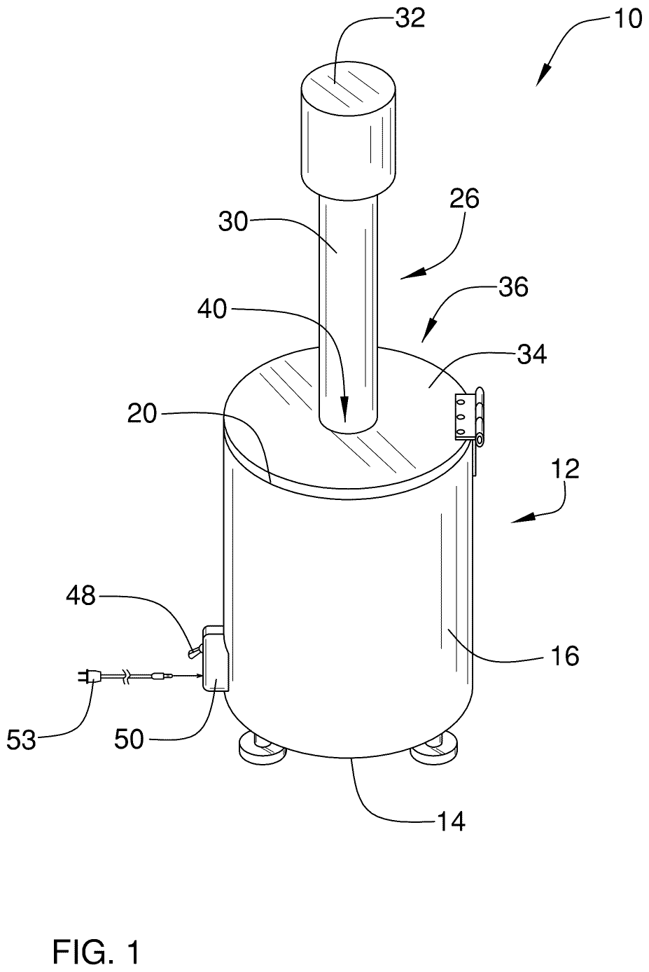

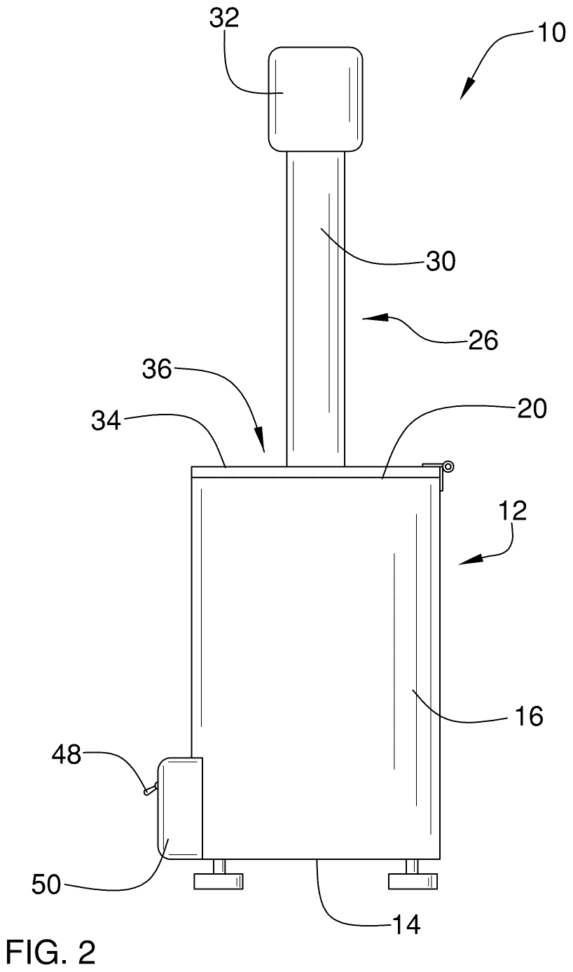

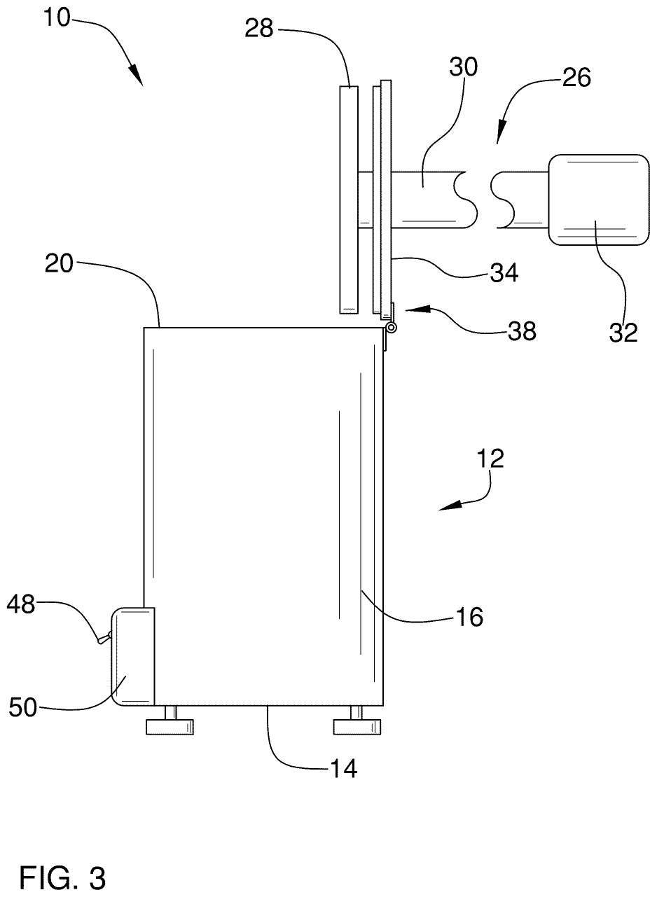

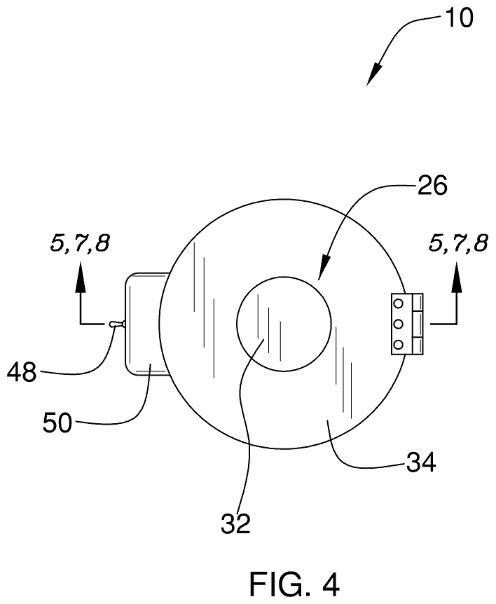

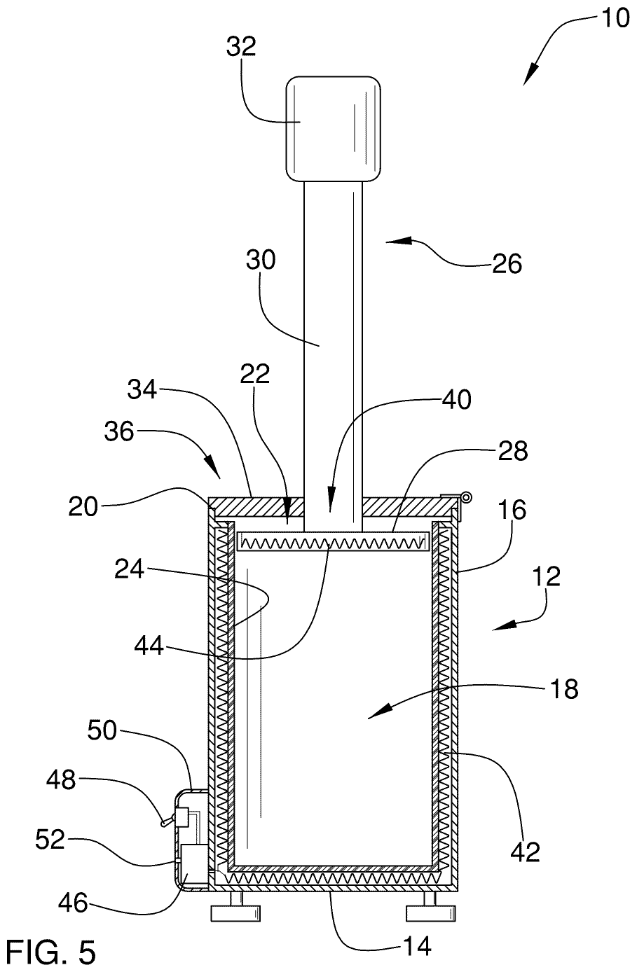

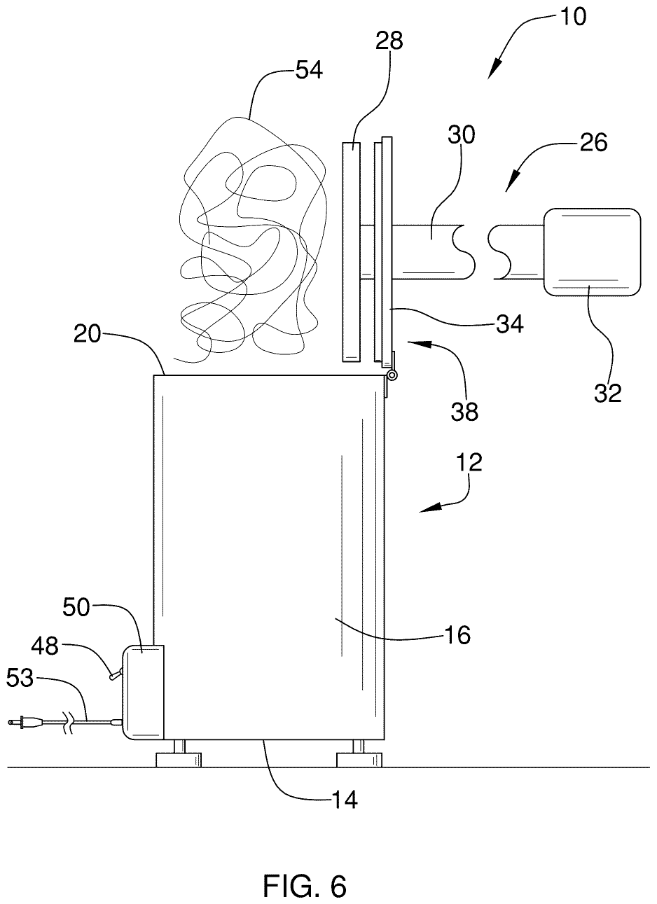

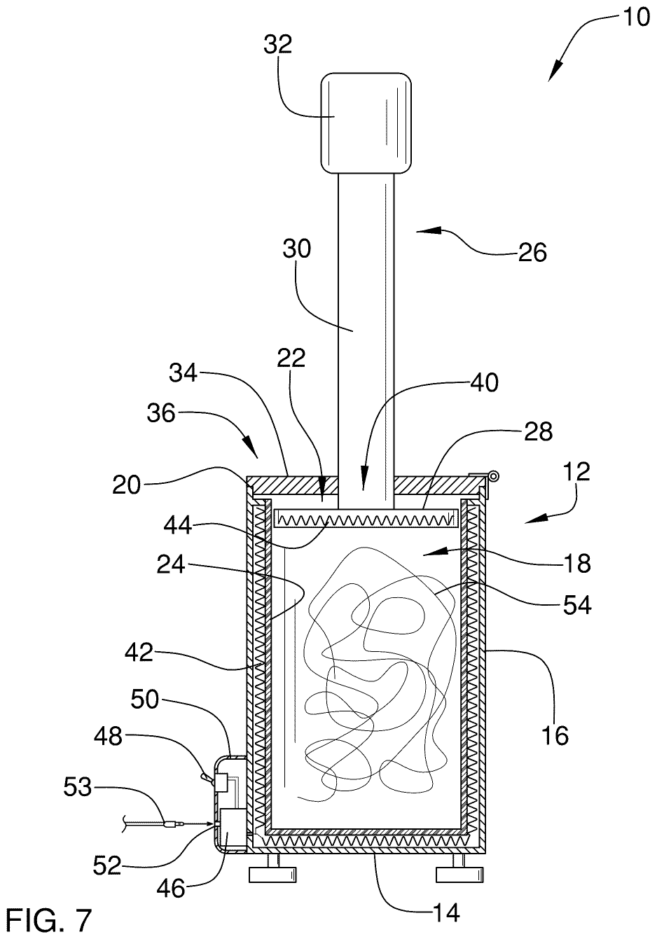

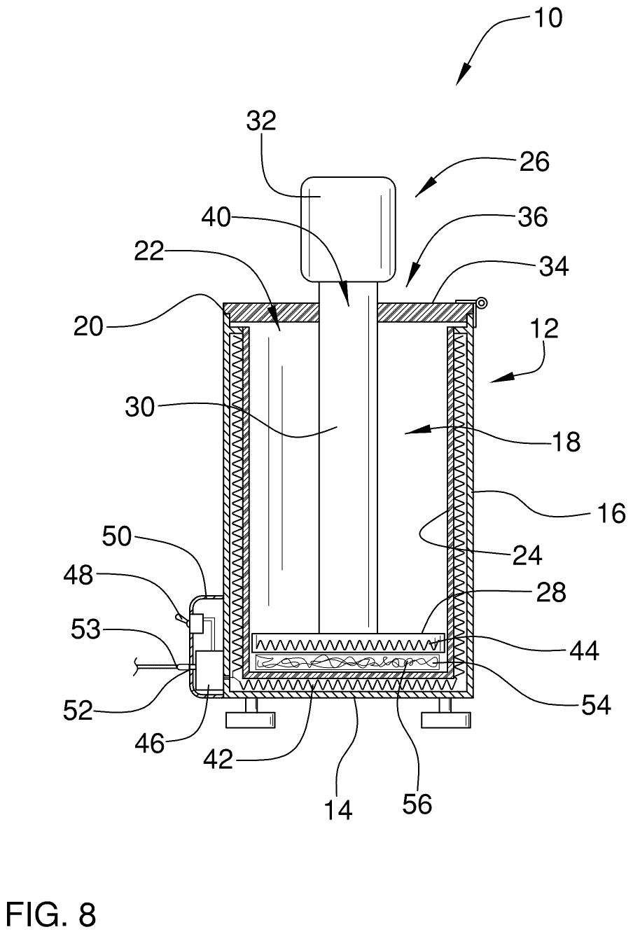

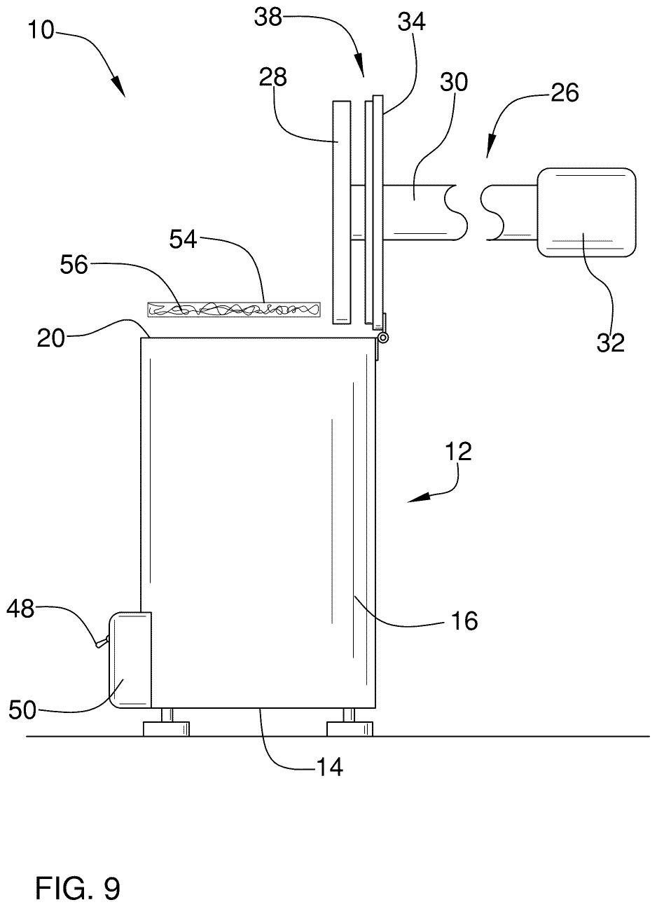

With reference now to the drawings, and in particular to FIGS. 1 through 10 thereof, a new forming device embodying the principles and concepts of an embodiment of the disclosure and generally designated by the reference numeral 10 will be described. As best illustrated in FIGS. 1 through 6, the forming device 10 generally comprises a container 12 with a bottom wall 14 and a perimeter wall 16. The perimeter wall 16 is coupled to and extends upwardly from the bottom wall 14. The container 12 defines an interior volume 18 bounded by the bottom wall 14 and the perimeter wall 16. A top edge 20 of the perimeter wall 16 defines an opening 22 to the interior volume 18 of the container 12. An interior portion 24 of the perimeter wall 16 comprises a frictionally reduced material such as polytetrafluoroethylene (PTFE)-commonly sold under the trademark TEFLON. Other frictionally reduced materials may be used such as ceramic coatings or other plastic materials. In some embodiments, an oil or other lubricant may be used.

A plunger 26 is slidably coupled to the interior volume 18 of the container 12. The plunger 26 comprises a head 28 which is complementary in shape to the interior volume 18 of the container 12, a rod 30 coupled to and extending away from the head 28, and a grip 32 coupled to the rod 30 opposite the head 28. A lid 34 is coupled to the container 12 and is movable between a closed position 36 and an open position 38 with respect to the opening 22 to the interior volume 18 of the container 12. The lid 34 is pivotably coupled to the perimeter wall 16 of the container 12. The lid 34 defines a through hole 40 which extends through the lid 34 and slidably receives the rod 30 of the plunger 26. The head 28 and the grip 32 of the plunger 26 may be sized larger than the through hole 40 such that they keep the plunger 26 coupled to the lid 34.

A container heater 42 is coupled to the container 12 and a plunger heater 44 is coupled to the plunger 26. The container heater 42 is embedded in the bottom wall 14 and the perimeter wall 16 of the container 12, while the plunger heater 44 is embedded in the head 28 of the plunger 26. The container heater 42 and the plunger heater 44 are activatable to heat the container 12 and the plunger 26 respectively, thereby heating contents held in the interior volume 18 of the container 12. The container heater 42 and the plunger heater 44 may comprise resistive heaters, but other forms of heat generation also may be used.

A power supply 46 electrically coupled to the container heater 42 and the plunger heater 44. Sliding electrical contacts (not shown) between the lid 34 and the rod 30 of the plunger 26 may be used to electrically couple the power supply 46 to the plunger heater 44. A switch 48 is electrically coupled to the power supply 46, the container heater 42, and the plunger heater 44. The switch 48 is actuatable to selectively power the container heater 42 and the plunger heater 44 via the power supply 46. A housing 50 is mounted to the container 12 and houses the power supply 46. The switch 48 is mounted on the housing 50. The power supply 46 comprises a battery, and a charging port 52 which extends through the housing 50 is provided to charge the battery via an external power source using a charging cord 53. In some embodiments, the plunger heater 44 and the container heater 42 may directly electrically couple to the external power source when the forming device 10 is used.

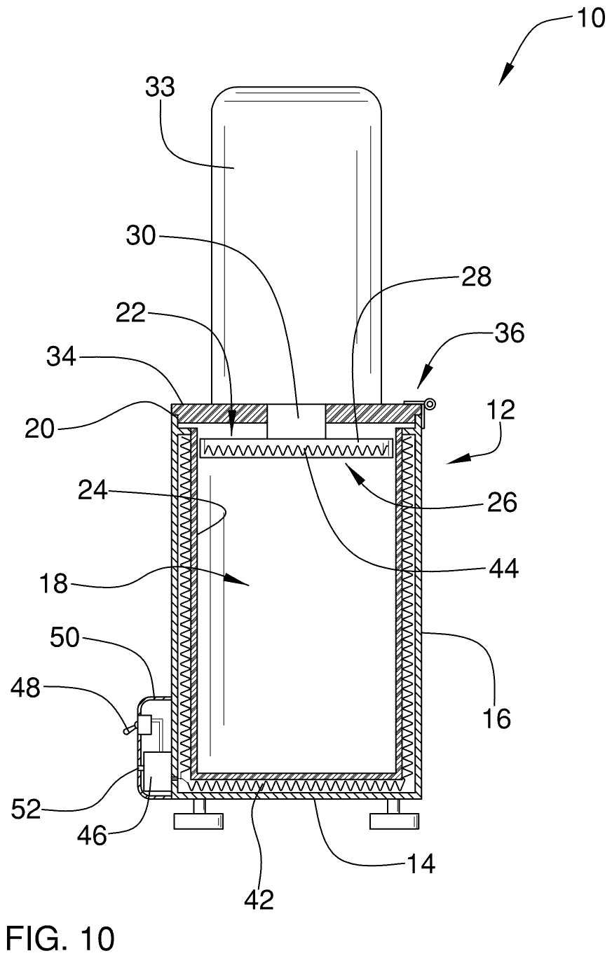

In some embodiments, such as depicted in FIG. 10, the plunger 26 may comprise a linear actuator 33 which drives the plunger 26. In those embodiments, the power supply 46 is electrically couplable to the linear actuator 33 via the switch 48.

In use, a fishing line 54 formed of a thermoplastic is placed into the interior volume 18 of the container 12. The plunger heater 44 and the container heater 42 are activated, which heats the fishing line 54 at least enough to become pliable enough to thermoform the fishing line 54. The fishing line 54 may be heated enough to melt in some cases. While or after the fishing line 54 is heated, the user presses the plunger 26 down to form the fishing line 54 into a compacted form 56. The compacted form 56 may, for example, have a disc shape if the interior volume 18 has a cylindrical shape.

The fishing line 54 is allowed to set into the newly formed shape by deactivating the container heater 42 and the plunger heater 44 or by removing the thermoplastic to another area where it can cool to set. The compacted form 56 of the fishing line 54 may then be disposed of without worrying about the fishing line 54 tangling and harming wildlife.

Other thermoplastic waste may also be formed in this manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A forming device for safely disposing of fishing line, the forming device comprising:
a container comprising a bottom wall and a perimeter wall, the perimeter wall being coupled to and extending upwardly from the bottom wall, the container defining an interior volume bounded by the bottom wall and the perimeter wall;
a plunger slidably coupled to the interior volume of the container; and
a heater configured to transmit heat into the interior volume of the container.

2. The forming device of claim 1:
wherein a top edge of the perimeter wall defines an opening to the interior volume of the container; and
further comprising a lid coupled to the container, the lid being movable between a closed position and an open position with respect to the opening to the interior volume of the container.

3. The forming device of claim 2, wherein:
the plunger comprises:
a head which is complementary in shape to the interior volume of the container;
a rod coupled to and extending away from the head; and
a grip coupled to the rod opposite the head; and
the lid defines a through hole which extends through the lid, the through hole slidably receiving the rod of the plunger.

4. The forming device of claim 3, wherein the lid is pivotably coupled to the perimeter wall of the container.

5. The forming device of claim 1, wherein an interior portion of the perimeter wall comprises a frictionally reduced material.

6. The forming device of claim 5, wherein the frictionally reduced material comprises polytetrafluoroethylene (PTFE).

7. The forming device of claim 1, wherein the heater is a container heater which is coupled to the container, the container heater being activatable to heat the container.

8. The forming device of claim 7, wherein the container heater is embedded in the bottom wall and the perimeter wall of the container.

9. The forming device of claim 7, further comprising a plunger heater coupled to the plunger, the plunger heater being activatable to heat the plunger.

10. The forming device of claim 1, wherein the heater is a plunger heater coupled to the plunger, the plunger heater being activatable to heat the plunger.

11. The forming device of claim 1, further comprising:
a power supply electrically coupled to the heater; and
a switch coupled to the power supply and the heater, the switch being actuatable to selectively power the heater via the power supply.

12. The forming device of claim 11, wherein the power supply is mounted on the container, the power supply comprising a battery.

13. A forming device for safely disposing of fishing line, the forming device comprising:
a container comprising a bottom wall and a perimeter wall, the perimeter wall being coupled to and extending upwardly from the bottom wall, the container defining an interior volume bounded by the bottom wall and the perimeter wall, a top edge of the perimeter wall defining an opening to the interior volume of the container, an interior portion of the perimeter wall comprising a frictionally reduced material, the frictionally reduced material comprising polytetrafluoroethylene (PTFE);
a plunger slidably coupled to the interior volume of the container, the plunger comprising:
a head which is complementary in shape to the interior volume of the container;
a rod coupled to and extending away from the head; and
a grip coupled to the rod opposite the head;
a container heater coupled to the container, the container heater being activatable to heat the container, the container heater being embedded in the bottom wall and the perimeter wall of the container;
a lid coupled to the container, the lid being movable between a closed position and an open position with respect to the opening to the interior volume of the container, the lid being pivotably coupled to the perimeter wall of the container, the lid defining a through hole which extends through the lid, the through hole slidably receiving the rod of the plunger;
a plunger heater embedded in the head of the plunger, the plunger heater being activatable to heat the head of the plunger;
a power supply electrically coupled to the container heater and the plunger heater, the power supply being mounted on the container, the power supply comprising a battery; and
a switch electrically coupled to the power supply, the container heater, and the plunger heater, the switch being actuatable to selectively power the container heater and the plunger heater via the power supply.
